(19) United States
(12) Patent Application Publication
(10) Pub. No.: US 2021/0377398 A1
(43) Pub. Date: Dec. 2, 2021

(54) IMAGE PROCESSING APPARATUS, METHOD FOR CONTROLLING THE SAME, STORAGE MEDIUM, AND IMAGE PROCESSING SYSTEM

(71) Applicant: Canon Kabushiki Kaisha, Tokyo (JP)

(72) Inventor: Yosui Naito, Nagareyama-shi (JP)

(21) Appl. No.: 17/400,230

(22) Filed: Aug. 12, 2021

Related U.S. Application Data
(63) Continuation of application No. 16/051,731, filed on Aug. 1, 2018, now abandoned.

(30) Foreign Application Priority Data
Aug. 3, 2017 (JP) 2017-151037

(51) Int. Cl. H04N 1/00

(52) U.S. Cl. CPC H04N 1/00209; H04N 1/00795; H04N 2201/0094; H04N 1/00352; H04N 1/00236

(57) ABSTRACT

The present image processing apparatus transmits the result of reading an original to an external terminal capable of communicating with the image processing apparatus, makes a user confirm the reading result on the external terminal, receives the confirmatory result of confirming the reading result from the external terminal, and registers the reading result to the image processing apparatus.

### CROSS-REFERENCE TO RELATED APPLICATIONS

The present application is a continuation application of U.S. patent application Ser. No. 16/051,731, filed Aug. 1, 2018, which claims priority to Japanese Patent Application No. 2017-151037, filed Aug. 3, 2017, the entire disclosures of which are hereby incorporated by reference herein.

### BACKGROUND OF THE INVENTION

### Field of the Invention

The present invention relates to an image processing apparatus, a method for controlling the same, a storage medium, and an image processing system for registering address information obtained from a read original, to an address book in an image processing apparatus.

### Description of the Related Art

A technique of registering destination information, such as an addresses and a telephone number written on a business card, to an address book provided in an image processing apparatus (hereinafter referred to as an MFP (Multi-Function Peripheral)) is known. For example, Japanese Patent Laid-Open No. 2009-164719 proposes a technique of scanning a business card on an MFP, performing optical character recognition (OCR) processing, and then displaying the result on an operation panel to make a user confirm the result. This is for allowing the user to confirm the OCR processing result and thereafter registering this result to the address book, since the OCR processing result is not always correct.

However, the above-described conventional technique has the following problems. For example, if the OCR processing result displayed on the operation panel of the MFP is incorrect, the OCR processing result needs to be modified using a software keyboard or a hardware ten key on the operation panel. The operation panel of an MFP is usually smaller than a monitor screen of a common PC, and it is not easy to confirm characters on an MFP compared with confirming on a PC. In addition, keys of a software keyboard on the operation panel on an MFP are usually small. For this reason, there are problems, in terms of visibility and operability, in thus confirming and correcting the OCR processing result on the operation panel provided on the MFP.

### SUMMARY OF THE INVENTION

The present invention enables realization of a mechanism for enabling a user to confirmatory results of reading by an image processing apparatus readily in terms of visibility and operability, and favorably registering the results to the image processing apparatus.

One aspect of the present invention provides an image processing apparatus comprising: a reader that reads an original; a communication interface that communicates with an external terminal; a memory device that stores a set of instructions; and at least one processor that executes the set of instructions to: transmit a reading result of reading by the reader to an external terminal capable of communicating with the image processing apparatus, via the communication interface; receive a confirmatory result of confirming the transmitted reading result, from the external terminal via the communication interface; and register information read by the reader to the image processing apparatus, in accordance with the received confirmatory result.

Another aspect of the present invention provides a method for controlling an image processing apparatus, comprising: reading an original; transmitting a reading result of the reading to an external terminal capable of communicating with the image processing apparatus; receiving a confirmatory result of confirming the reading result transmitted due to the transmitting, from the external terminal; and registering information read by the reader to the image processing apparatus, in accordance with the confirmatory result received due to the receiving.

Still another aspect of the present invention provides a non-transitory computer-readable storage medium storing a program for causing a computer to execute steps of a method for controlling an image processing apparatus, the method comprising: reading an original; transmitting a reading result of the reading to an external terminal capable of communicating with the image processing apparatus; receiving a confirmatory result of confirming the reading result transmitted due to the transmitting, from the external terminal; and registering information read by the reader to the image processing apparatus, in accordance with the confirmatory result received due to the receiving.

Yet still another aspect of the present invention provides an image processing system in which an image processing apparatus and an external terminal can communicate with each other, the image processing apparatus comprising: a reader that reads an original; a communication interface that communicates with an external terminal; a memory device that stores a set of instructions; and at least one processor that executes the set of instructions to: transmit a reading result of reading by the reader to an external terminal capable of communicating with the image processing apparatus, via the communication interface; receive a confirmatory result of confirming the transmitted reading result, from the external terminal via the communication interface; and register information read by the reader to the image processing apparatus, in accordance with the received confirmatory result, and the external terminal comprises: a display unit that displays a confirmatory screen for confirming the transmitted reading result; a user interface that accepts, via the confirmatory screen, a confirmatory result of confirmation by a user; and a communication interface that transmits, to the image processing apparatus, the confirmatory result accepted by the user interface.

Further features of the present invention will be apparent from the following description of exemplary embodiments with reference to the attached drawings.

### BRIEF DESCRIPTION OF THE DRAWINGS

FIG. 1 is a diagram showing a configuration of an image processing system.

FIG. 2 is a block diagram showing a hardware configuration of an MFP 102.

FIG. 3 is a block diagram showing a software configuration of the MFP 102.

FIG. 4 is a diagram showing data structures of destinations registered in an address book 803.

FIG. 5 is a diagram showing a destination registration screen displayed on an operation panel 209 of the MFP 102.

FIG. 6 is a diagram showing a one-touch registration screen displayed on the operation panel 209 of the MFP 102.

FIG. 7A is a diagram showing a business card reading screen displayed on the operation panel 209 of the MFP 102.

FIG. 7B is a diagram showing a screen for setting a transmission destination of a reading completion notification, displayed on the operation panel 209 of the MFP 102.

FIG. 7C is a diagram showing a pop-up window appearing after a business card has been read, displayed on the operation panel 209 of the MFP 102.

FIG. 8 is a diagram showing a business card reading completion notification e-mail.

FIG. 9 is a diagram showing a confirmatory screen for a business card reading result, displayed on a remote UI of the MFP 102.

FIG. 10A is a diagram showing a confirmatory screen for a business card reading result, displayed on the operation panel 209 of the MFP 102.

FIG. 10B is a diagram showing a registration screen for a new fax destination, displayed on the operation panel 209 of the MFP 102.

FIG. 10C is a diagram showing a registration screen for a new e-mail destination, displayed on the operation panel 209 of the MFP 102.

FIGS. 11A and 11B are diagrams showing a business card reading flow of the MFP 102 when registering a destination.

FIG. 12 is a flowchart of operations of an external terminal 101 in the case of confirming and registering a destination from the remote UI.

FIG. 13 is a flowchart of operations of the MFP 102 in the case of accepting confirmation and registration of a destination from the remote UI.

FIGS. 14A and 14B are flowcharts of operations of the MFP 102 in the case of confirming and registering a destination on the operation panel 209.

FIG. 15 is a diagram showing a reading result data structure that is temporarily saved when the MFP 102 reads a business card.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Configuration of Image Processing System

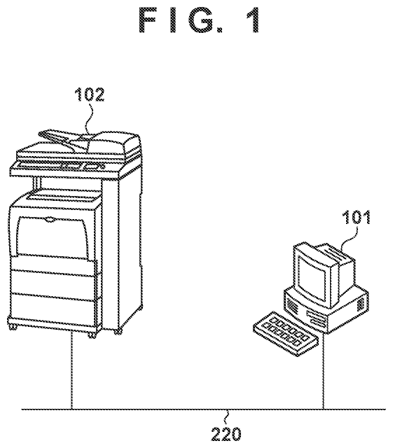

The first embodiment of the present invention will be described below. First, a configuration example of an image processing system according to this embodiment will be described with reference to FIG. 1. This image processing system has a configuration in which an external terminal 101 and an MFP 102 are connected to each other via a network 220, and are communicable with each other. Note that the present invention is not intended to be limited to the system shown in FIG. 1, and may alternatively be configured to include a plurality of external terminals, MFPs, or other devices in addition to the system configuration in FIG. 1. The external terminal 101 is an apparatus that acquires information read by the MFP 102 and presents the information so that a user can confirm the information. The MFP 102 transmits read information obtained by reading an original, such a business card, to the external terminal 101, and makes the user confirm the read information. Upon receiving a notification indicating that the read information has been confirmed from the external terminal 101, the MFP 102 registers this read information therein. That is to say, in this system, information read by the MFP 102 is transmitted to a remote device (external terminal 101) that enables a user to readily confirm the information, and after the information has been confirmed, the confirmed information is registered to a local device, namely the MFP 102.

Hardware Configuration of MFP 102

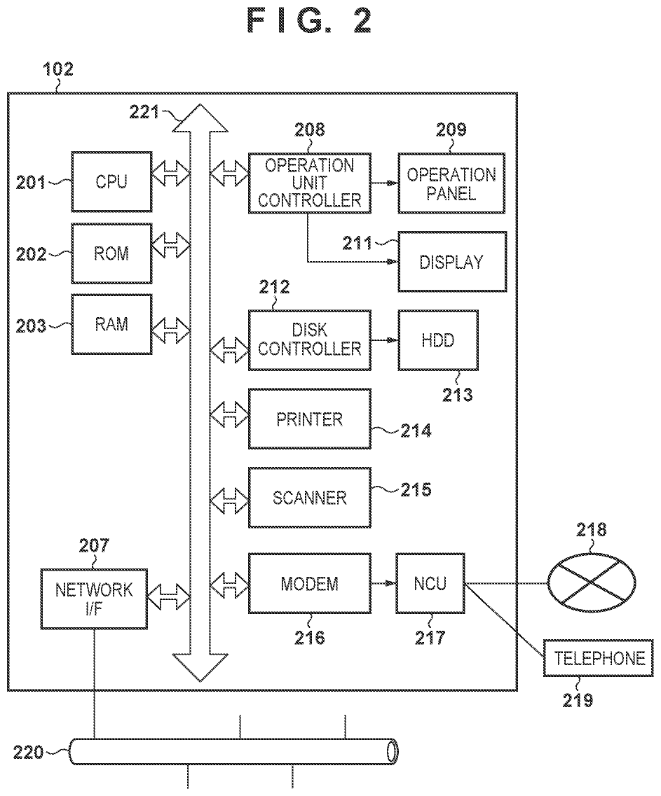

Next, an example of a hardware configuration of the MFP 102 according to this embodiment will be described with reference to FIG. 2. The MFP 102 includes a CPU 201 that executes software stored in a ROM 202 or a HDD (hard disk drive) 213. The CPU 201 comprehensively controls devices connected to a system bus 221. Note that the HDD 213 may also be used as an area for temporarily storing images, depending on the case.

203 denotes a RAM that functions as a main memory, a work area, and the like of the CPU 201. 208 denotes an operation unit controller that controls various buttons, an operation panel 209, a display 211, and so on, provided on the MFP 102. 212 denotes a disk controller that controls access to the HDD 213.

207 denotes a network I/F, which bidirectionally transmits and receives exchanges data to and from other network devices, file servers, or the like, via a network 220. 214 denotes a printer that is a unit for printing on paper and is realized with an electrophotographic method. The printing method may not particularly be an electrophotographic method. 215 denotes a scanner that is an image reading unit for reading an image printed on paper. In many cases, the scanner 215 is optionally equipped with an ADF (auto-document feeder; not shown), and can automatically read a plurality of originals.

216 denotes a modem that demodulates a modulated signal received from a telephone line 218, or conversely, modulates a signal from a device and outputs the modulated signal to the telephone line 218. An NCU (Network control unit) 217 corresponds to an interface portion between the telephone line 218 and a facsimile, and performs line control to detect a signal received via the telephone line 218 and transmit the detected signal to the modem 216, and switch the telephone line 218 between the facsimile and a telephone 219.

Software Configuration

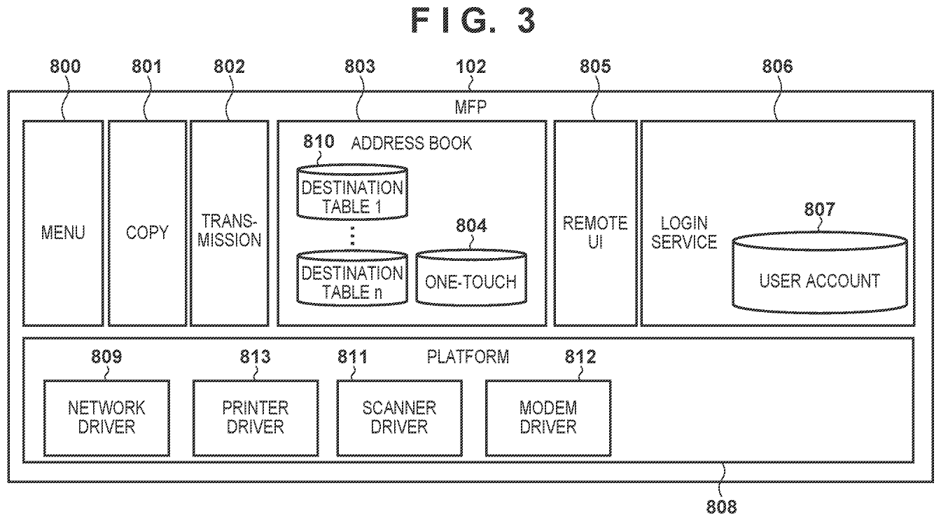

Next, a software configuration according to this embodiment will be described with reference to FIG. 3. FIG. 3 shows a software configuration of the MFP 102, and data areas managed by the software. An address book 803, a one-touch 804, and a user account 807 are data areas for data recorded on a RAM 203 or a HDD 213 and managed by the software. Destinations are stored in the address book 803 and the one-touch 804. The details will be described later. Data such as an authority setting and an e-mail address for each user account are stored in the user account 807.

A platform 808 includes, for example, an operating system such as Linux (registered trademark), a JAVA (registered trademark) virtual machine, an OSGi framework, and a device driver group. The OSGi framework is a JAVA (registered trademark)-based platform defined by the OSGi Alliance (standards organization). The platform 808 includes device drivers for controlling various kinds of hardware, and provides an API for using hardware to an application that operates on the platform. The platform 808 includes drivers, namely a network driver 809, a printer driver 813, a scanner driver 811, and a modem driver 812. The network driver 809 controls a network I/F control unit 207. The printer driver 813 controls the printer 214. The scanner driver 811 controls the scanner 215. The modem driver 812 controls the modem 216.

A copy 801 and a transmission 802 are applications that operate on the platform 808, and display user interfaces for providing various functions on the display 211. For example, the copy 801 controls the scanner 215 and the printer 214 via the platform 808, and executes copying. The transmission 802 provides a function of controlling the scanner 215 and the network I/F 207 or the modem 216 to transmit read document data to the network 220 or the telephone line 218. As for the destination for transmission, a newly-input destination or a destination saved in the address book 803 can be used.

A menu 800 is a module for displaying a menu for selecting an application (e.g. copy, transmission) on the display 211. A remote UI 805 provides a user interface or the like for managing settings of the MFP 102. A login service 806 is a module for providing a login function for using the MFP 102.

The address book 803 includes a plurality of destination tables 810 and one one-touch 804. Destinations saved in the destination tables 810 and destinations saved in the one-touch 804 can be referenced in the address book 803. Meanwhile, only destinations saved in the one-touch 804 can be referenced during a one-touch operation. Here, “one-touch operation” refers to an operation to select a predetermined destination associated with an operation key provided on the MFP 102 by operating this operation key.

Address Book Data

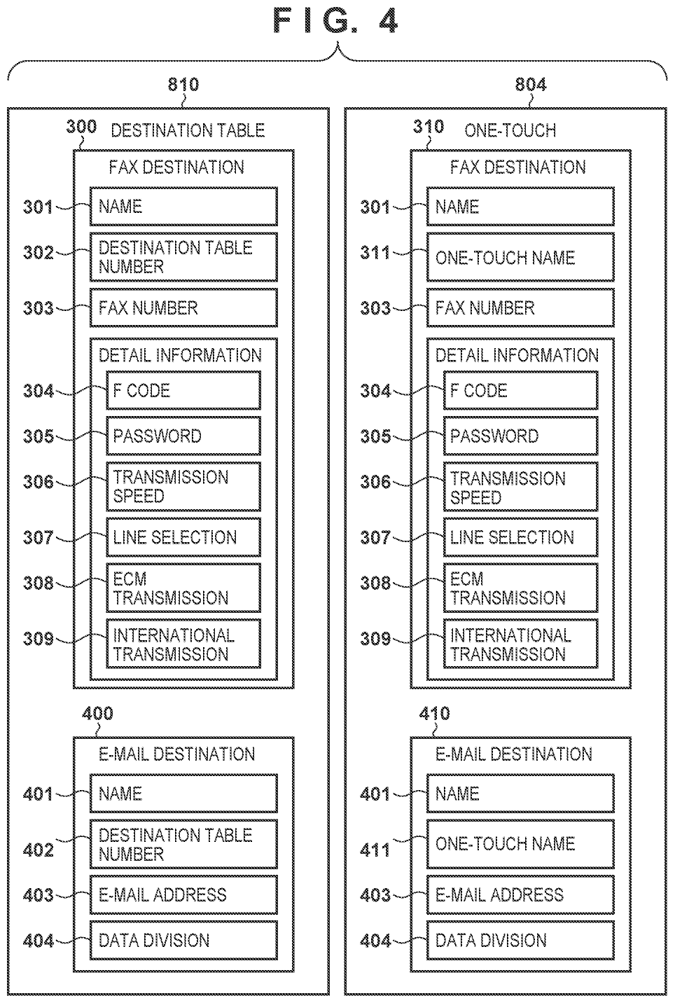

Next, details of destination data registered in the destination tables 810 and the one-touch 804 will be described using FIG. 4. 300 denotes a structure of a fax destination registered in a destination table 810. 301 denotes a name that is given by a user to identify the destination. Any kind of character string, such as that indicating a person name or a company name, can be registered as this name. 302 denotes a destination table number that indicates the destination table (1 to n) in which the destination is registered. 303 denotes a fax number.

The fax destination 300 includes the following detail information. 304 and 305 denote an F code and a password, respectively, both of which are registered optionally. 306 denotes a transmission speed, which can be selected from among the speeds defined by the T.30 standard for fax. 307 denotes line selection. If a plurality of modems 216 are mounted and a plurality of telephone lines 218 are connectable, a line number to be used for transmission can be designated with the line selection 307. An automatic selection setting, i.e. automatically selecting a line that can be used for transmission from among a plurality of lines can also be configured. 308 denotes a setting of enabling or disabling an ECM (Error Correction Mode) for fax transmission. 309 denotes designation of an international transmission mode. A domestic transmission mode is set as a default, but the international transmission mode can be set in the case of a destination for international communication. In the case of international communication, voice on the telephone line delays significantly, or a fax cannot be stably sent over high-speed communication due to characteristics of the line. For this reason, if the international transmission mode is set, the transmission speed value is fixed to low speed, and a timer for addressing a delay is extended.

310 denotes a structure of a fax destination registered in the one-touch 804. The fax destination 310 only differs from the fax destination 300 in that the fax destination 310 does not include the destination table number 302, but includes a one-touch name 311 instead. The one-touch name 311 is a display name that is to be displayed for the one-touch operation. Other information is the same as that of the fax destination 300, and descriptions thereof are omitted.

400 denotes a structure of an e-mail destination registered in a destination table 810. 401 denotes a name that is given by a user to identify the destination. Any kind of character string, such as that indicating a person name or a company name, can be registered. 402 denotes a destination table number. 403 denotes an e-mail address. 404 denotes a setting of enabling or disabling data division when transmitting an e-mail. Since a permissible upper limit size of one e-mail is defined by an e-mail server, and an e-mail with a size that exceeds the upper limit size incurs an error in the server, if the size of an e-mail exceeds a designated size, the data division setting is enabled to divide one e-mail and transmit this e-mail as a plurality of e-mails, in order to avoid the error.

410 denotes a structure of an e-mail destination registered in the one-touch 804. The e-mail destination 410 differs from the e-mail destination 400 in that the e-mail destination 410 does not include the destination table number 402, but includes a one-touch name 411 instead. Other information is the same as that of the e-mail destination 400, and descriptions thereof are omitted.

Destination Registration Screen of MFP 102

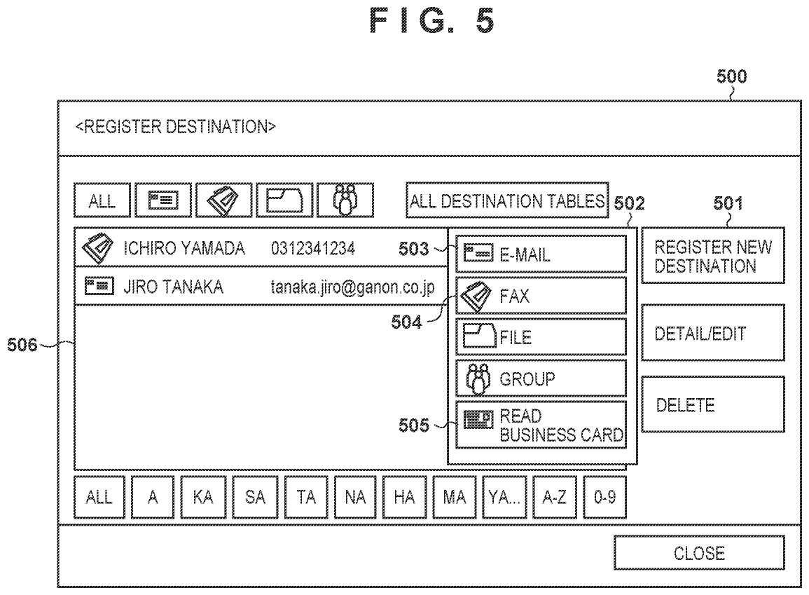

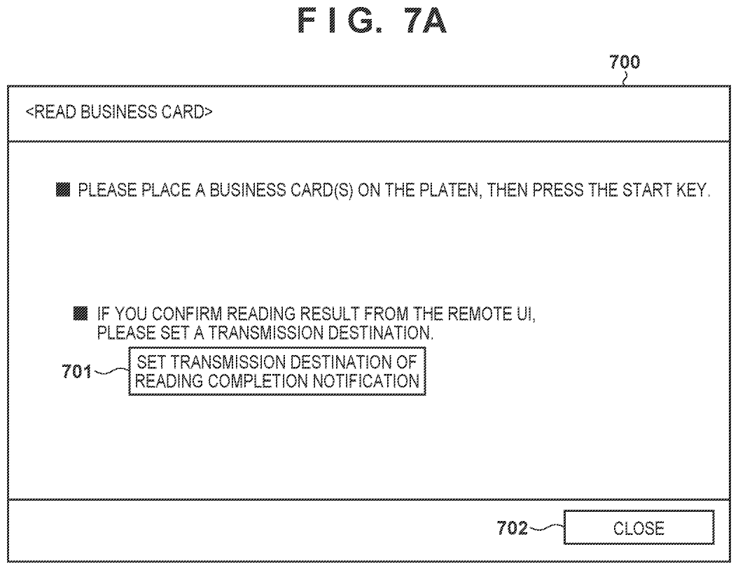

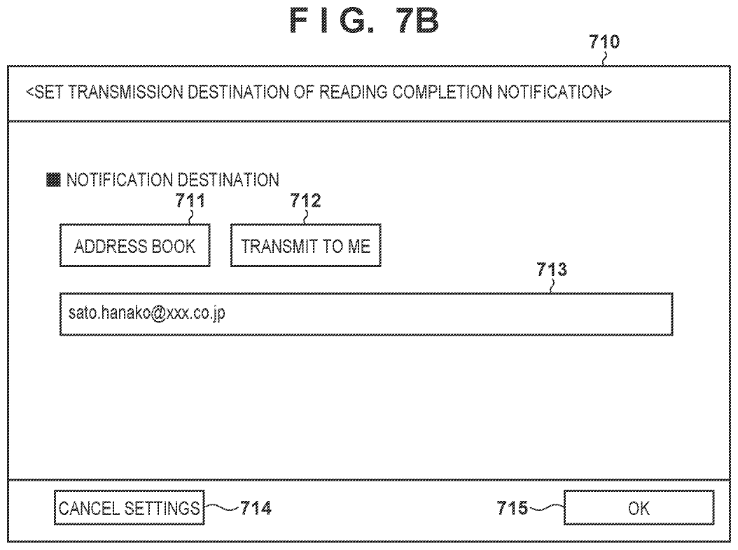

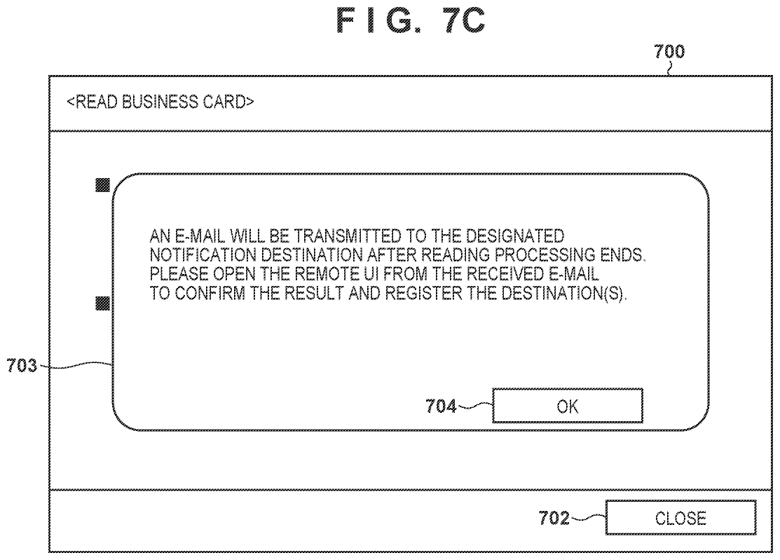

Next, a destination registration screen 500 of the MFP 102 will be described with reference to FIG. 5. In the destination registration screen 500 shown in FIG. 5, 506 denotes a destination display area. Already-registered destinations are displayed in the destination display area 506. 501 denotes a button for registering a new destination. Upon this new destination registration button 501 being operated, a registration type selection screen denoted by 502 is displayed. In the selection screen 502, a button 503 for registering the e-mail destination 400, a button 504 for registering the fax destination 300, and so on, are displayed. A business card reading button 505 for registering a destination based on a read business card that serves as an original, is also displayed in the selection screen 502. Upon the business card reading button 505 being operated, the screen transitions to a business card reading screen 700, which will be described with reference to FIGS. 7A-7C.

One-Touch Registration Screen of MFP 102

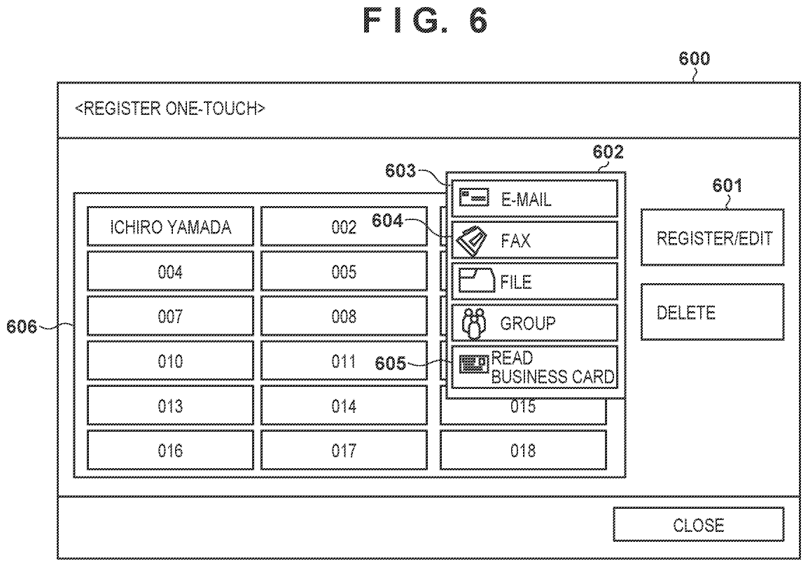

Next, a one-touch registration screen 600 of the MFP 102 will be described with reference to FIG. 6. In the one-touch registration screen 600 shown in FIG. 6, 606 denotes a one-touch display area. 601 denotes a button for registering a new one-touch destination. Upon operating this new registration button 601, a registration type selection screen denoted by 602 is displayed. In the selection screen 602, a button 603 for registering the e-mail destination 410, a button 604 for registering the fax destination 310, and so on, are displayed. A business card reading button 605 for registering a destination based on a read business card, which serves as an original, is also displayed in the selection screen 602. Upon the business card reading button 605 being operated, the screen transitions to a business card reading screen 700, which will be described with reference to FIGS. 7A-7C.

Business Card Reading Screen of MFP 102

Next, a business card reading screen 700 of the MFP 102 will be described with reference to FIG. 7A. 701 denotes a button for setting a transmission destination of a reading completion notification in the case of confirming the result of reading a business card on the external terminal 101. Upon the transmission destination setting 701 being operated, the screen transitions to a screen 710 for setting a transmission destination of the reading completion notification shown in FIG. 7B. 702 denotes a button for closing the business card reading screen 700. Upon the business card reading screen 700 being closed, the screen returns to the previous screen (the destination registration screen 500 or the one-touch registration screen 600) from which the screen transitioned to the business card reading screen 700.

The screen 710 for setting a transmission destination of the reading completion notification includes an address book button 711 for setting a transmission destination from the address book 803, and a “transmit to me” button 712 for acquiring a destination associated with a logged-in user from the user account 807 and automatically setting this destination. 713 denotes a display area in which a set transmission destination is displayed. Upon an OK button 715 being operated with a transmission destination displayed in the display area 713, the transmission destination of the reading completion notification is determined, and the screen returns to the business card reading screen 700. Upon a setting cancel 714 being operated, the set transmission destination is cleared, and the screen returns to the business card reading screen 700. Note that, although the setting of a transmission destination in the case of confirming the reading result on a remote device such as the external terminal 101 is described here, the present invention is not limited thereto, and the reading result can also be confirmed on the MFP 102. That is to say, the reading result can be confirmed on the operation panel 209 of the MFP 102 by the user operating the button 702 while not operating the transmission destination setting 701 in the business card reading screen 700.

FIG. 7C illustrates a state of displaying a message pop-up window 703 after ending scanning in the case where the reading completion notification transmission destination setting 701 has been configured. The message pop-up window 703 displays a message indicating that an e-mail is to be transmitted to the notification destination designated after completing business card reading processing, the result can be confirmed on a URL of the remote UI written in the e-mail, and a destination can be registered to the MFP 102 using information read from the business card. 704 denotes an OK button for closing the message pop-up window 703.

Business Card Reading Completion Notification

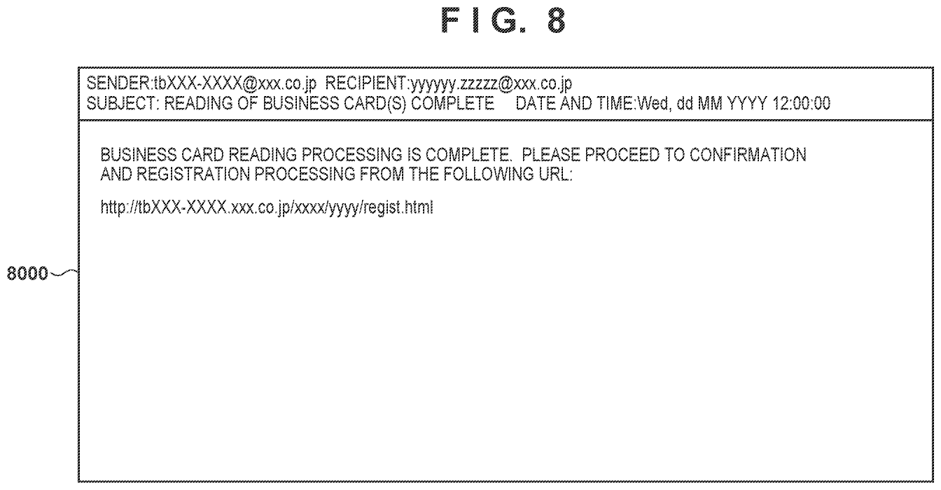

Next, a description will be given, with reference to FIG. 8, of an example of a completion notification e-mail that is to be transmitted to the external terminal 101 in the case where the business card reading completion notification transmission destination setting 701 has been configured. 8000 denotes an email text area that displays message text indicating that reading of a business card has been completed by the MFP 102, and a URL (access information) of the remote UI 805 of the MFP 102. In addition, message text is displayed indicating that the reading result can be confirmed and corrected on this URL, and a destination can be registered to the address book 803 using the content of the reading result. Thus, the user can access a confirmatory page for the reading result on the remote UI 805 only by opening this e-mail and clicking the URL, and accordingly will not hesitate about the operation. With this configuration, the image processing apparatus according to this embodiment can provide an operation system that is user-friendly in terms of operability.

Business Card Reading Result Confirmatory Screen Displayed on External Terminal 101

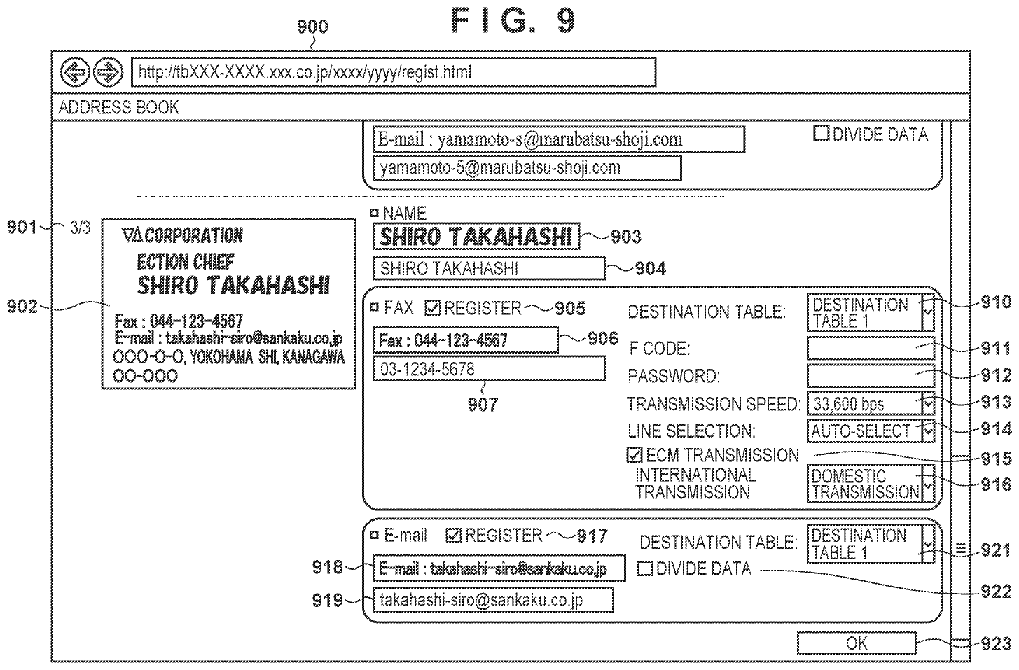

Next, a confirmatory screen 900 for the business card reading result on the remote UI 805 will be described with reference to FIG. 9. This screen is displayed on a display unit of the external terminal 101 by accessing the URL written on the e-mail text area 8000 in FIG. 8. The confirmatory screen 900 is a screen that displays the result of reading by the MFP 102 in a modifiable manner, and in which an instruction to register the reading result can be given to the MFP 102 in accordance with user input. 901 denotes a label indicating the number of the business card that is currently displayed, out of all read business cards. The display example indicates that the displayed business card is the third one out of three read business cards. 902 denotes a preview image of the business card, which is a read image. 903 denotes an enlarged preview image of a name portion. Various methods may be used as the method of cutting out the name portion. For example, since the name is often displayed with the largest font in a business card, a character string may be determined as a name based on the font size thereof, using this characteristic, and then cut out. Otherwise, the number of characters or the like may also be used as an additional basis for determination. Note that, since there is no reliable conditions for the determination of the name portion, a plurality of candidates may be displayed in a pull-down menu. 904 denotes a text area for displaying text of the result of performing OCR processing on the name portion. The user compares the preview image 902 with the result in 904, and if the result is incorrect, the text area 904 can be edited.

905 denotes a check box for selecting whether or not to register a fax number as a fax destination 300 to the address book 803. A fax number can be registered by checking the check box 905. 906 denotes an enlarged preview image of a fax number portion. An area that includes “FAX” and a number string is extracted from the OCR processing result and is displayed as the enlarged preview image 906. 907 denotes a text area for displaying text of the result of performing OCR processing on a fax number portion. Here, the fax number portion is displayed while deleting “FAX”. There are cases where “-” (hyphens) and/or brackets are included in a fax number, and in such cases, control may be performed so as to display such hyphens and/or brackets as-is in the text display area 907 and delete them when registering the fax number to the address book 803. Otherwise, such hyphens and/or brackets may be deleted when displaying the fax number on the text display area 907. The user compares the preview image 906 with the result in 907, and if the result is incorrect, the text area 907 can be edited.

910 to 916 are registration items that can be set when a fax destination 300 is registered to the address book 803. Default values may be displayed for required items. 910 denotes a destination table number, which corresponds to the destination table number 302 of the fax destination 300. 911 denotes an F code, which corresponds to the F code 304 of the fax destination 300. 912 denotes a password, which corresponds to the password 305 of the fax destination 300. 913 denotes a transmission speed, which corresponds to the transmission speed 306 of the fax destination 300. 914 denotes line selection, which corresponds to the line selection 307 of the fax destination 300. 915 denotes a transmission ECM setting, which corresponds to the transmission ECM setting 308 of the fax destination 300. 916 denotes international transmission, which corresponds to the international transmission 309 of the fax destination 300. Note that, if the one-touch 804, rather than a destination table 810, is selected with the destination table number 910, an input text area (not shown) for a one-touch name is displayed, and the fax number is registered as a one-touch fax destination 310.

917 denotes a check box for selecting whether or not to register an acquired e-mail address as an e-mail destination 400 to the address book 803. An e-mail address can be registered by checking the check box 917. 918 denotes an enlarged preview image of an e-mail address portion. An e-mail address portion is extracted from the OCR processing result under the condition that a character string includes “E-mail” (or a similar character string), or a character string includes “@”. 919 denotes a text area for displaying text of the result of performing OCR processing on the e-mail address. The user compares the preview image 918 with the result in 919, and if the result is incorrect, the text area 919 can be edited.

921 and 922 are registration items that can be set when the e-mail address 400 is registered to the address book 803. Default values may be displayed for required items. 921 denotes a destination table number, which corresponds to the destination table number 402 of the e-mail destination 400. 922 denotes a data division setting, which corresponds to the data division setting 404 of the e-mail destination 400. Note that, if the one-touch 804, rather than the destination table 810, is selected with the destination table number 921, an input text area (not shown) for a one-touch name is displayed, and the e-mail address is registered as a one-touch e-mail destination 410.

923 denotes an OK button for registering a confirmed and corrected destination to the address book 803 of the MFP 102. Although this embodiment describes an example of confirming destinations written on all business cards and then collectively registering the destinations with the OK button 923, buttons for individually registering the addresses may also be arranged.

Confirmatory Screen for Business Card Reading Result Displayed on MFP 102

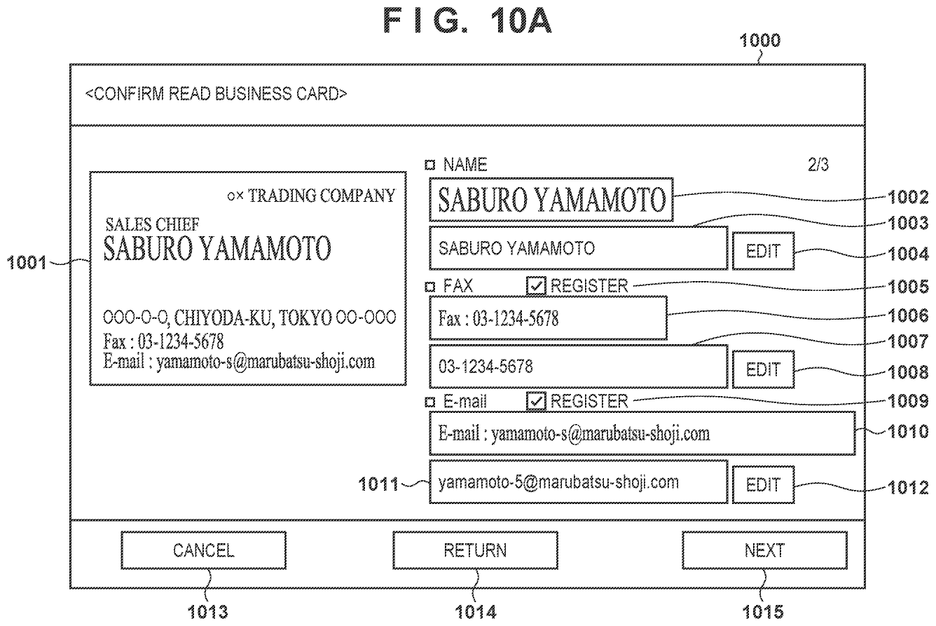

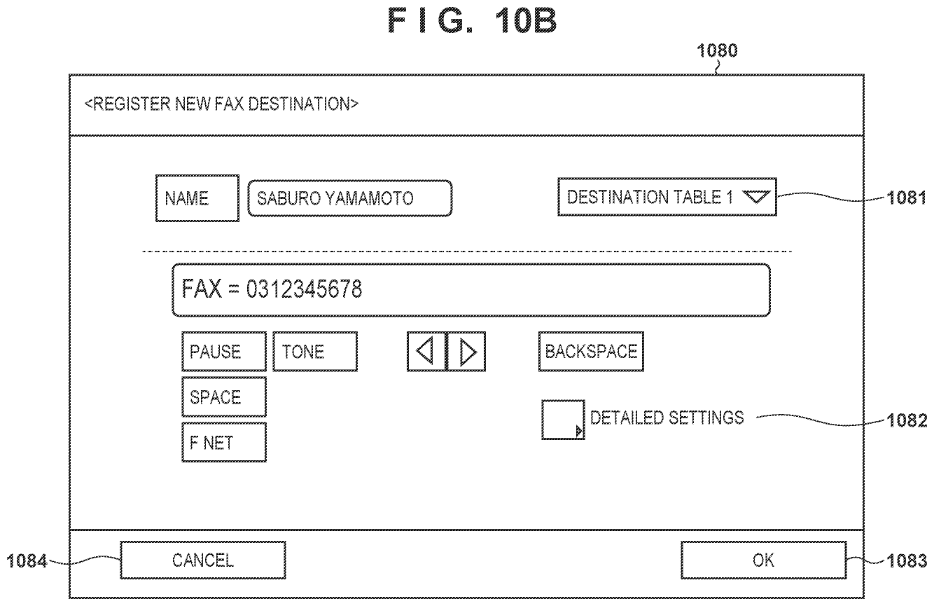

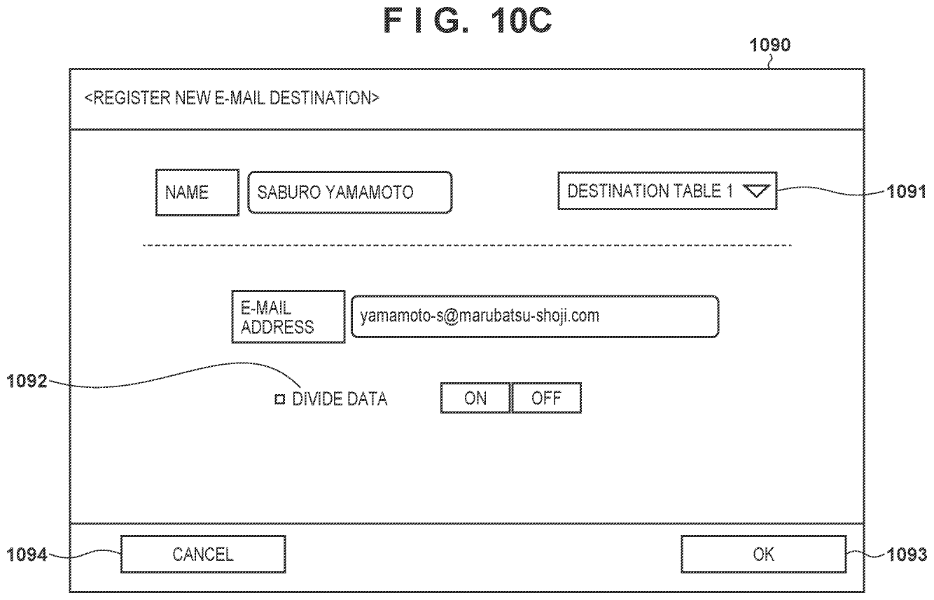

Next, a description will be given, with reference to FIGS. 10a to 10c, of a confirmatory screen for the business card reading result that is displayed on the operation panel 209 in the case of displaying a confirmatory screen for the business card reading result on the MFP 102, rather than the external terminal 101. FIG. 10A shows a confirmatory screen 1000.

In the confirmatory screen 1000, 1001 denotes a preview image of a business card that is read from an original. 1002 denotes an enlarged preview image of a name portion. 1003 denotes a text area for displaying text of the result of performing OCR processing on the name portion. The text area 1003 corresponds to the name 301 and the one-touch name 311 for a fax destination 300. 1004 denotes an edit button for calling a software keyboard to edit the text in 1003.

1005 denotes a check box for selecting whether or not to register a fax number as a destination. The check box 1005, upon being checked, enters a selected state, and the screen can then transition to a later-described registration screen 1080 of FIG. 10B. 1006 denotes an enlarged preview image of a fax number portion. 1007 denotes a text area for displaying text of the result of performing OCR processing on the fax number portion. Note that the fax number may also be able to be edited using a ten key (not shown) arranged on the operation panel 209. The text area 1007 corresponds to the fax number 303 of a fax destination. 1008 denotes an edit button for calling a software keyboard to edit the text in 1007.

1009 denotes a check box for selecting whether or not to register an e-mail address as a destination. The check box 1009, upon being checked, enters a selected state, and the screen can then transition to a later-described registration screen 1090 of FIG. 10C. 1010 denotes an enlarged preview image of an e-mail address portion. 1011 denotes a text area for displaying text of the result of performing OCR processing on the e-mail address portion. 1012 denotes an edit button for calling a software keyboard to edit the text in 1011.

1013 denotes a cancel button for discontinuing confirmation and registration processing in the middle and returning to the screen from which the screen has transitioned. In this embodiment, upon the cancel button 1013 being operated, the screen returns to the destination registration screen 500 or the one-touch registration screen 600. 1014 denotes a return button for returning to the previous screen, namely the business card reading result screen. 1015 denotes a next button for transitioning to a registration screen for registering new fax and e-mail destinations. If the check box 1005 that indicates whether or not to register the fax destination is ON, the screen transitions to the registration screen 1080 for registering a new fax destination, and values of the name 1003 and the fax number 1007 are set onto the screen displayed after the transition. In the registration screen 1080 for registering a new fax destination, other attributes that cannot be acquired from a business card can be set from a destination table selection list 1081 and a detail information button 1082 as needed. Items settable with the detail information button 1082 are items 304 to 309 of the fax destination 300. The screen to be displayed after pressing the detail information button 1082 is not described or shown in the diagrams. Upon pressing an OK button 1083, the fax destination 300 is registered to the address book 803.

If the check box 1009 that indicates whether or not to register the e-mail destination is ON on the confirmatory screen 1000 for the business card reading result, the screen transitions from the confirmatory screen 1000 or the registration screen 1080 to the registration screen 1090 for registering a new e-mail destination. Values of the name 1003 and the e-mail address 1011 are displayed on the screen displayed after the transition. In the registration screen 1090 for registering a new e-mail destination as well, other attributes that cannot be acquired from a business card can be set from a destination table selection list 1091 and data division 1092 as needed. Upon pressing an OK button 1093, the e-mail destination 400 is registered to the address book 803.

Note that, in the registration screen 1080 for registering a new fax destination and the registration screen 1090 for registering a new e-mail destination, upon a cancel button 1084 or 1094 being operated, the screen returns to the confirmatory screen 1000 for the business card reading result.

As mentioned above, if the displayed content of the confirmatory screen 900 to be displayed on the external terminal 101 is displayed on the MFP 102, the screen is displayed while being divided into the confirmatory screen 1000 and the two registration screens 1080 and 1090. This is, commonly, due to a difference between the display size of a display of a PC, such as the external terminal 101, and the display size of the operation panel 209 of the MFP 102. That is to say, the operation panel 209 of the MFP 102 is a small liquid-crystal display provided in an operation unit, and has a resolution and display size that are inferior to those of a PC display. Accordingly, the user can take more advantage of a further improved operation system in terms of visibility and operability, when confirming the reading result on the external terminal 101 such as a PC, than when confirming the reading result on the display of the MFP 102.

Processing Flow to Read Business Card on MFP 102

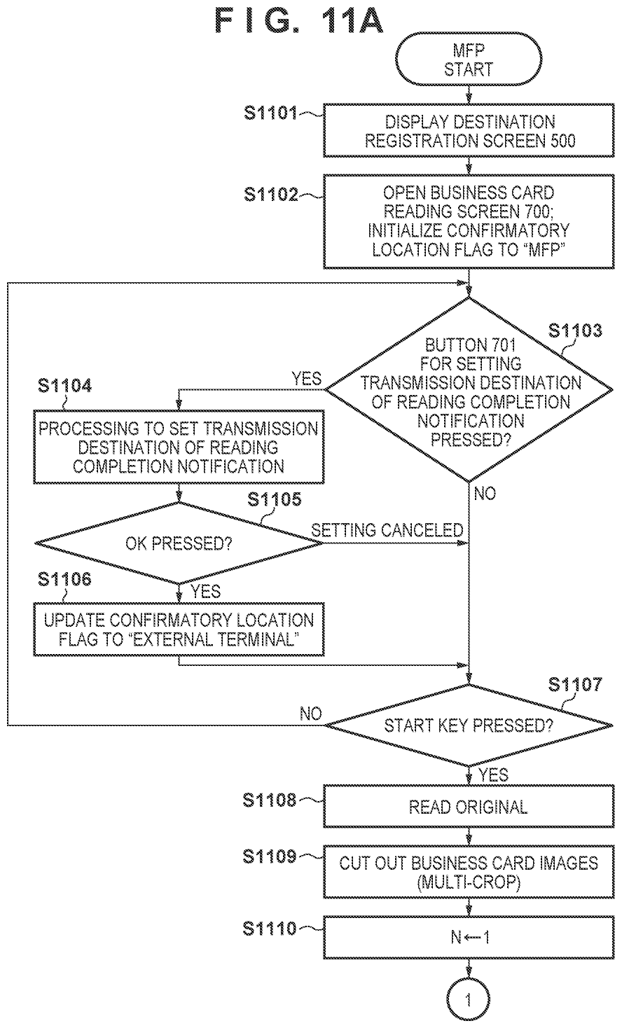

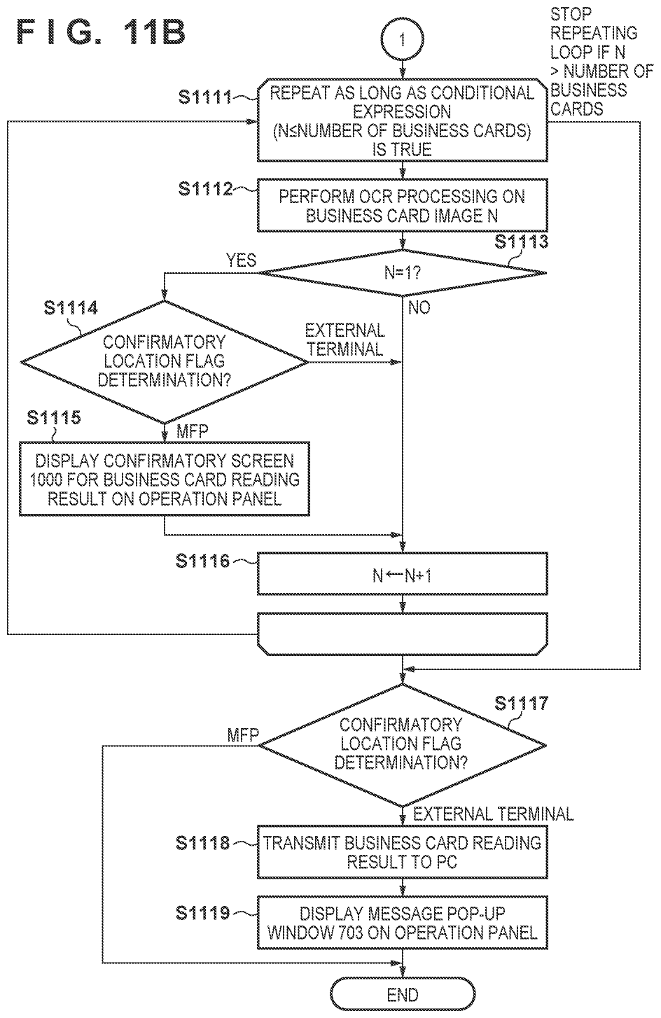

Next, a description will be given, with reference to FIGS. 11A and 11B, of a processing procedure to read a business card on the MFP 102 in order to read a business card and register a destination on the destination registration screen 500. Note that the series of processing is realized by loading a program that describes the following procedure and can be executed by the MFP 102, from the ROM 202 to the RAM 203, and then executing this program with the CPU 201.

Initially, in step S1101, the operation unit controller 208 of the MFP 102 displays the destination registration screen 500 on the operation panel 209. Thereafter, in step S1102, upon detecting that the business card reading button 505 has been pressed, the operation unit controller 208 displays the business card reading screen 700 on the operation panel 209, and initializes a confirmatory location flag, which is a variable, to “MFP”. Here, the confirmatory location flag is a flag for defining information that indicates a device for confirming the reading result of reading an original by the MFP 102, and is stored in the RAM 203. In this embodiment, “MFP” or “external terminal” can be designated as the confirmatory location flag, but other devices may also be designated. In step S1103, the operation unit controller 208 determines whether or not the button 701 for setting a transmission destination of the reading completion notification being pressed has been detected. If detected, the screen 710 for setting a transmission destination of the reading completion notification is displayed, and transmission destination setting processing is performed.

In step S1105, the operation unit controller 208 determines whether or not the OK button 715 in the transmission destination setting screen 710 has been selected. If the screen has been ended by the OK button 715 being pressed, the processing proceeds to step S1106. It is here assumed that, in the setting processing in step S1104, an e-mail address that can be received by the external terminal 101 is set as the destination of the notification. In step S1106, the CPU 201 updates the confirmatory location flag for the reading result to “external terminal” in accordance with the settings, and the processing proceeds to step S1107. If the processing in step S1104 has ended due to canceling the settings, the confirmatory location flag is not updated, and the processing proceeds to step S1107.

In step S1107, the operation unit controller 208 detects whether or not a start key has been pressed. If the operation unit controller 208 does not detect that the start key has been pressed, the processing returns to step S1103. If the operation unit controller 208 detects that the start key has been pressed, the processing returns to step S1108, the CPU 201 controls the scanner 215 to read an original (e.g. one or more business cards) placed on a platen, and stores an acquired image in the HDD 213. Subsequently, in step S1109, the CPU 201 detects edges of business card images on the obtained image based on image shade information or the like, cuts out images of respective business card images one by one, and saves the obtained business card images to the HDD 213.

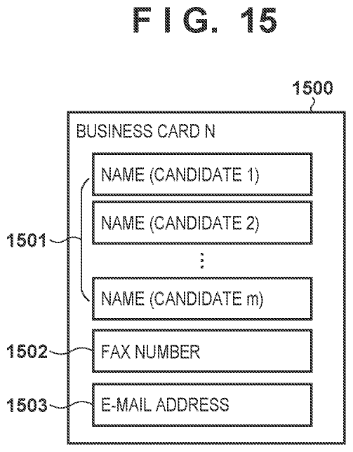

Next, in step S1110, the CPU 201 initializes a variable N to 1, and executes loop processing indicated at step S1111 until N exceeds the number of business card images obtained in step S1109. In the loop processing starting from step S1111, in step S1112, the CPU 201 executes OCR processing on an N^{th} business card image, and stores obtained text information in the RAM 203. Specifically, the CPU 201 extracts portions that correspond to a name, a fax number, and an e-mail address from acquired character information, as described with reference to FIG. 9. The acquired values are stored in the form of a reading result data structure 1500 shown in FIG. 15, in the RAM 203. 1501 in the reading result data structure 1500 denotes areas for saving name text read from a business cards. A plurality of areas are provided because there are cases where a plurality of name candidates are saved. 1502 denotes an area for saving a fax number, and 1503 denotes an area for saving an e-mail address. A plurality of candidates may also be able to be saved in the respective areas 1502 and 1503. Note that data of the reading result data structure 1500 is prepared for the number of business cards that can be processed by the MFP 102.

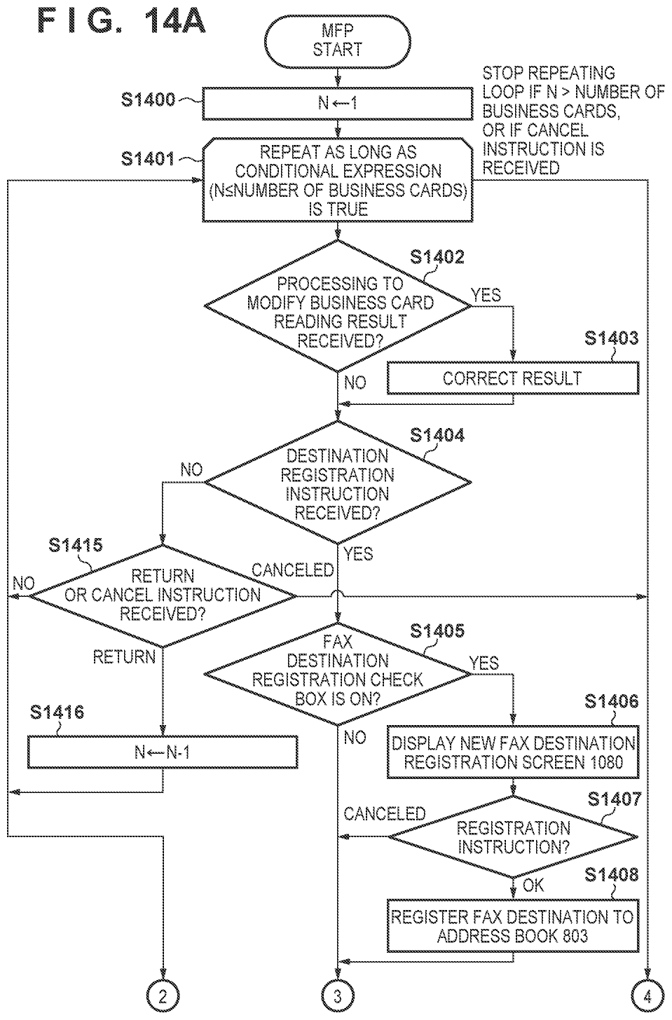

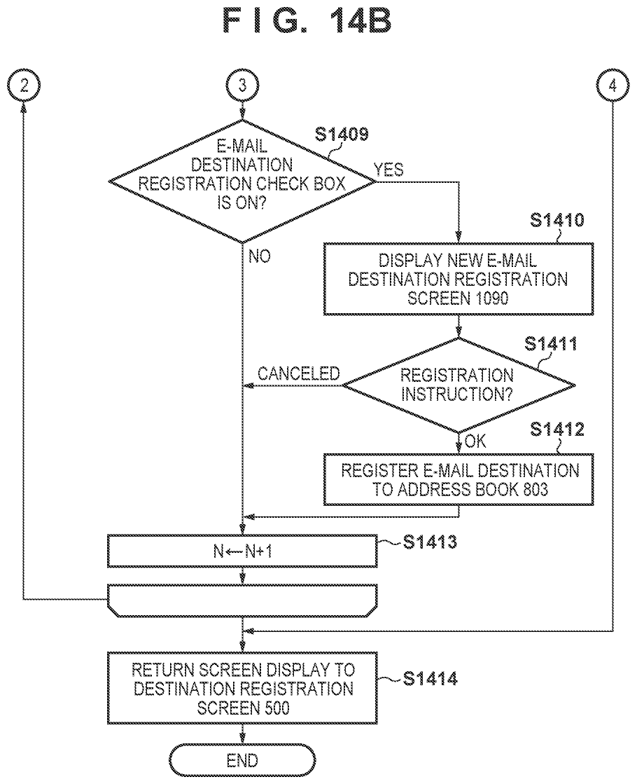

Subsequently, in step S1113 in the loop processing starting from step S1111, the CPU 201 determines whether or not N is 1, advances the processing to step S1114 if N is 1, and judges the value of the confirmatory location flag. If the confirmatory location flag is set to “MFP”, the processing proceeds to step S1115. In step S1115, the operation unit controller 208 displays the confirmatory screen 1000 for the business card reading result in order to have the reading result confirmed on the operation panel 209 of the MFP 102. If the reading result is to be confirmed on the MFP 102, the confirmatory screen is thus displayed when reading processing for the first business card ends, and performs reading processing for the second and subsequent business cards in the background while the user is confirming the reading result. A flow in the case of confirming and registering values on the confirmatory screen 1000 for the business card reading result will be described later using FIGS. 14A and 14B. On the other hand, if the confirmatory location flag is set to “external terminal”, confirmation will be carried out on the external terminal 101 through the remote UI 805, and accordingly, the processing proceeds to step S1116 without performing step S1115. In step S1116, the CPU 201 increments the value of N, and returns to the top of the loop processing starting from S1111.

After the loop processing starting from S1111 has ended, in step S1117, the CPU 201 again judges the value of the confirmatory location flag, and advances the processing to step S1118 if the confirmatory location flag is set to “external terminal”. In step S1118, the CPU 201 sets, as text, the content indicated in the e-mail text 8000 in FIG. 8, creates an e-mail while designating, as a destination, the notification destination set in step S1104, and transmits the e-mail to the network 220 through the network I/F 207. Subsequently, in step S1119, the CPU 201 displays the message pop-up window 703 indicating that a notification is made to the designated destination after the reading processing is complete, on the business card reading screen 700 that is currently displayed on the operation panel 209, and ends the processing. If, in step S1117, the confirmatory location flag is set to MFP, the CPU 201 ends the processing as-is while performing any other steps.

Processing Flow in the Case of Receiving Completion Notification and Confirming Business Card Reading Result on External Terminal 101

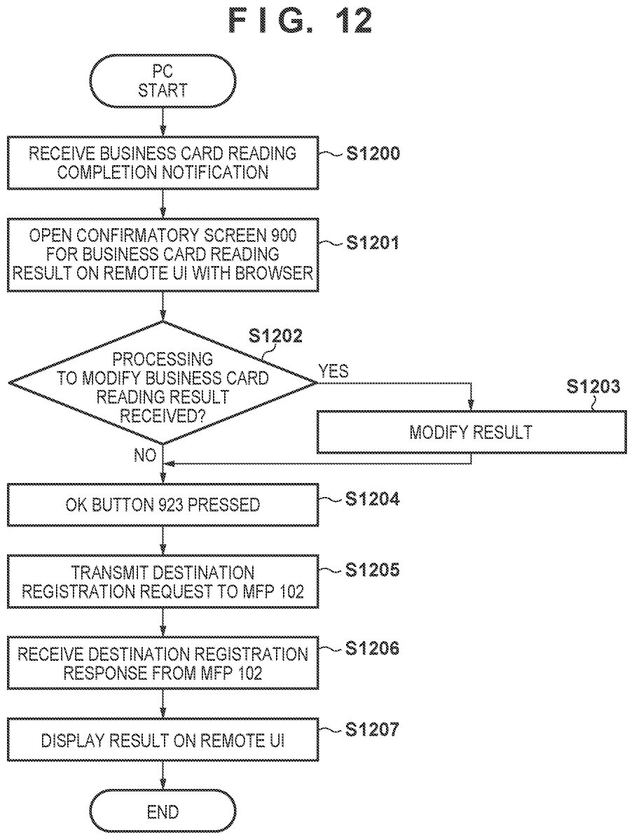

Next, a description will be given, with reference to FIG. 12, of a processing flow of the external terminal 101 from when receiving the business card reading completion notification until when registering a destination. Note that the following processing is realized by the CPU of the external terminal 101 loading a control program stored in the ROM or the like to the RAM and executing it.

In step S1200, the CPU of the external terminal 101 receives a completion notification e-mail from the network 220. Subsequently, in step S1201, the external terminal 101 opens a URL written in the text of the received e-mail with a browser, in accordance with a user operation. In step S1202, the CPU of the external terminal 101 determines whether or not processing to modify the business card reading result has been accepted. If processing to correct the name 904, the fax number 907, and/or the e-mail address 919 of the business card reading result has been accepted, the processing proceeds to step S1203. If not, the processing proceeds to step S1204. In step S1203, the CPU of the external terminal 101 updates a corresponding item to a modified value, and the processing proceeds to step S1204.

If, in step S1204, the OK button 923 has been pressed, in step S1205, the CPU of the external terminal 101 transmits a destination registration request to the MFP 102 over the network 220. In the case of a fax destination, the destination registration request includes an attribute value of the fax destination 300 or the one-touch fax destination 310 shown in FIG. 4. In the case of an e-mail destination, the destination registration request includes an attribute value of the e-mail destination 400 or the one-touch e-mail destination 410 that are also shown in FIG. 4. Subsequently, if, in step S1206, the CPU of the external terminal 101 has received a destination registration response from the MFP 102 over the network 220, in step S1207, the CPU of the external terminal 101 displays the result of destination registration on the remote UI screen on the browser, and ends the processing.

Processing Flow in the Case of Receiving Request for Remote UI 805 from External Terminal 101

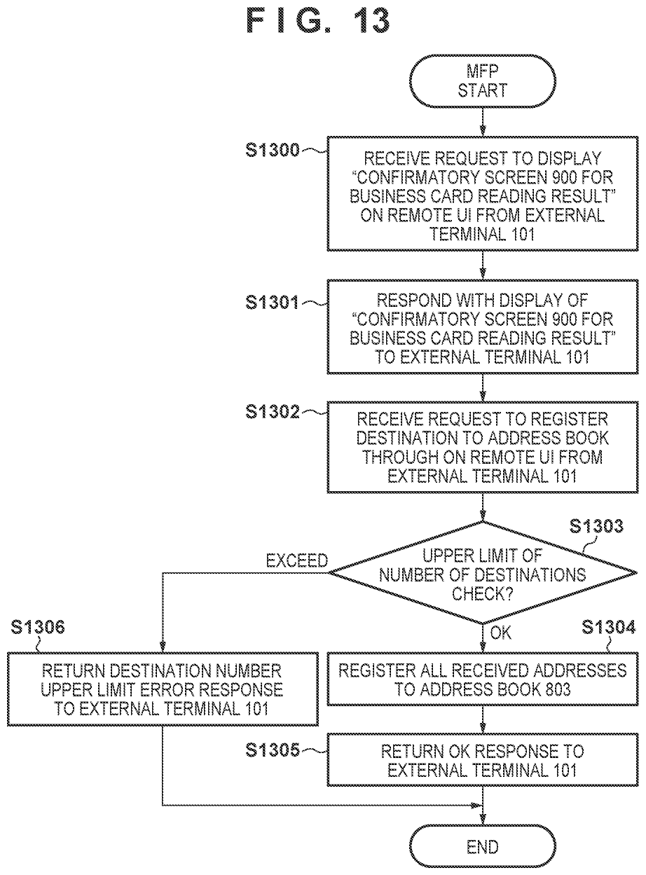

Next, a description will be given, with reference to FIG. 13, of a processing flow in the case where the MFP 102 receives a request for the remote UI 805 from the external terminal 101. Note that the series of processing is realized by loading a program that describes the following procedure and can be executed by the MFP 102, from the ROM 202 to the RAM 203, and then executing this program with the CPU 201.

In step S1300, the CPU 201 detects, using the network I/F 207, a request, which is transmitted from the external terminal 101, to display the confirmatory screen 900 for the business card reading result of the remote UI 805. Then, in step S1301, the CPU 201 generates a screen display response (screen information) on the remote UI 805, and returns the response from the network I/F 207 to the network 220. The screen display response contains a preview image of a read business card, the results of performing OCR on a name, a fax number, and an e-mail address, and cut-out images of the respective image areas.

Next, in step S1302, the CPU 201 detects, using the network I/F 207, a request (instruction) to register the destinations on the remote UI 805, the request being the confirmatory result transmitted from the external terminal 101. In step S1303, the CPU 201 checks the number of received destinations and the number of destinations in the address book 803 that are already saved in the HDD 213, and checks whether or not the upper limit number of registerable destinations is to be exceeded. If it is determined that the upper limit number is not to be exceeded, the processing proceeds to step S1304, and the CPU 201 saves all of the received destination data in the HDD 213. In step S1305, the CPU 201 returns a response indicating that the registration has been successful, to the external terminal 101 through the network I/F 207, and ends the processing. Here, the received destination data is the confirmatory result of confirmation made on the display of the external terminal 101. Accordingly, if the destination data (destination information) has been modified, the confirmatory result also includes modification information, and further includes information for giving an instruction to register the reading result to the MFP 102. On the other hand, if it is determined that the upper limit number of registerable destinations is to be exceeded, the processing proceeds to step S1306, the CPU 201 returns a destination upper limit error response to the external terminal 101 through the network I/F 207, and ends the processing.

Processing Flow in the Case of Confirming Reading Result on Operation Panel 209 of MFP 102

Next, a description will be given, with reference to FIGS. 14A and 14B, of a processing flow of the MFP 102 in the case of confirming the business card reading result on the operation panel 209 of the MFP 102. Note that the series of processing is realized by loading a program that describes the following procedure and can be executed by the MFP 102, from the ROM 202 to the RAM 203, and then executing this program with the CPU 201. This processing flow starts with the confirmatory screen 1000 for the business card reading result displayed on the operation panel 209.

Initially, in step S1400, the CPU 201 initializes the variable N to 1. Then, the CPU 201 performs loop processing starting from step S1401, which will be described below, until the variable N exceeds the number of read business cards.

Initially, in step S1402, the operation unit controller 208 determines whether or not processing to modify the business card reading result has been accepted. Here, if it is detected that any of the name edit button 1004, the fax number edit button 1008, and the e-mail address edit button 1010 has been pressed, the operation unit controller 208 determines that modification processing has been accepted, and the processing proceeds to step S1403. If not, the processing proceeds to step S1404. In step S1403, the operation unit controller 208 displays a software keyboard to enable modification of the text. Upon modification being determined with the software keyboard, the saved text is updated. Thereafter, in step S1404, the operation unit controller 208 determines whether or not a destination registration instruction has been accepted. Until it is detected that the “next” button 1015 has been pressed, in step S1415, the operation unit controller 208 determines whether or not a return instruction or a cancel instruction has been accepted. If a return instruction has been accepted, in step S1416, the operation unit controller 208 sets the variable N to N−1, and returns to the top of the loop. However, a return button 1014 can be pressed only when N is 2 or greater. If a cancel instruction has been accepted, the operation unit controller 208 stops performing the loop, and the processing proceeds to step S1414. If neither a return instruction nor a cancel instruction has been accepted, the processing returns to the top of the loop without updating the variable N.

On the other hand, if, in step S1414, it is detected that the “next” button 1015 has been pressed, the processing proceeds to step S1405, and the operation unit controller 208 determines whether or not the check box 1005 that indicate whether or not to register a fax destination, is ON. If the check box 1005 is ON, the processing proceeds to step S1406, and the operation unit controller 208 displays the new fax destination registration screen 1080 on the operation panel 209. On the other hand, if the check box 1005 is OFF, the processing proceeds to step S1409.

After the display of the new fax destination registration screen 1080 has ended in step S1406, a setting of additional information, such as the destination table number, is enabled, but a processing flow related to the setting of additional information is omitted here. Subsequently, in step S1407, the operation unit controller 208 determines whether or not a registration instruction has been accepted, by determining whether or not the OK button 1083, which is a destination registration instruction, has been pressed. If it is detected that the OK button 1083 has been pressed, the processing proceeds to step S1408, and the CPU 201 saves the fax destination to the address book 803 in the HDD 213. If the number of destinations has already reached the maximum number, the CPU 201 does not save the fax destination to the address book 803, and causes the operation unit controller 208 to display an error message on the display panel 209. If, in step S1407, it is detected that the cancel button 1084 has been pressed, no destination is saved, and the processing proceeds to step S1409.

In step S1409, the operation unit controller 208 determines whether or not the check box 1009 that indicates whether to register an e-mail destination, is ON. If the check box 1009 is ON, the processing proceeds to step S1410, and the operation unit controller 208 displays the new e-mail destination registration screen 1090 on the operation panel 209. If the check box 1009 is OFF, the processing proceeds to step S1413.

After the display of the new e-mail destination registration screen 1090 has ended in step S1410, a setting of addition information, such as the destination table number, is enabled, but a processing flow related to the setting of additional information is omitted here. Subsequently, in step S1411, the operation unit controller 208 determines whether or not a registration instruction has been accepted, by determining whether or not the OK button 1093, which is a destination registration instruction, has been pressed. If it is detected that the OK button 1093 has been pressed, the processing proceeds to step S1412, and the CPU 201 saves the e-mail destination to the address book 803 in the HDD 213. If the number of destinations has already reached the maximum number, the CPU 201 does not save the e-mail destination to the address book 803, and causes the operation unit controller 208 to display an error message on the display panel 209. If, in step S1411, it is detected that the cancel button 1094 has been pressed, no destination is saved, and the processing proceeds to step S1413.

In step S1413, the CPU 201 increments the value of N, and returns to the top of the processing loop. After the processing loop (S1401) has ended, the processing proceeds to step S1414, and the operation unit controller 208 displays the destination registration screen 500, from which the screen has transitioned, on the operation panel 209, and ends the processing.

As described above, the image processing apparatus transmits the result of reading an original to an external terminal capable of communicating with the image processing apparatus, makes a user confirm the reading result on the external terminal, receives the confirmatory result of confirming the reading result from the external terminal, and registers the reading result to the image processing apparatus. Thus, the image processing apparatus according to this embodiment makes it possible for a user to confirm the reading result on the external terminal, which is a remote device that enables the confirmation to be performed readily in terms of operability and visibility, and also makes it possible to give, from this external terminal, an instruction to register the read information to the image processing apparatus. That is to say, according to this embodiment, the OCR processing result can be confirmed on a monitor of an external terminal that has a larger display region than that of the image processing apparatus, and thus, visibility is improved. Furthermore, the OCR processing result can be corrected using a hardware keyboard of an external terminal that is more operable than the image processing apparatus, and thus, operability is improved. Accordingly, it is possible to simplify operations to acquire destination information from an image obtained by scanning a business card and register the destination information to an address book in the image processing apparatus, and suppress occurrence of erroneous operations.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, a user can confirm the results of reading by an image processing apparatus, readily in terms of visibility and operability, and the results can be favorably registered to the image processing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-151037 filed on Aug. 3, 2017, which is hereby incorporated by reference herein in its entirety.

1.-12. (canceled)

13. An image processing apparatus comprising:
a reader that generates image data by reading at least a first document and a second document based on one reading instruction received from a user; and
a controller that performs character recognizing processing on the image data to obtain text information,
wherein the controller extracts from the obtained text information first destination information corresponding to the first document and second destination information corresponding to the second document.

14. The image processing apparatus according to claim 13, further comprising a network interface that transmits the extracted first destination information and the extracted second destination information to an external terminal.

15. The image processing apparatus according to claim 14, wherein the extracted first destination information and the extracted second destination information, which are transmitted by the network interface, can be modified by the external terminal.

16. The image processing apparatus according to claim 14, wherein a destination of the external terminal can be set by a user.

17. The image processing apparatus according to claim 13, wherein the first destination information corresponding to the first document and the second destination information corresponding to the second document can be extracted as destination information corresponding to different documents.

18. The image processing apparatus according to claim 13, wherein the extracted first destination information is an e-mail address and the extracted second destination information is an e-mail address.

19. The image processing apparatus according to claim 13, wherein the extracted first destination information is a facsimile number and the extracted second destination information is a facsimile number.

20. The image processing apparatus according to claim 13, wherein the extracted first destination information is an e-mail address and the extracted second destination information is a facsimile number.

21. The image processing apparatus according to claim 13, further comprising an auto document feeder.

22. The image processing apparatus according to claim 13, wherein the first document is a first business card and the second document is a second business card.

23. The image processing apparatus according to claim 13, wherein the controller further extracts, from the obtained text information, a first name corresponding to the first document and a second name corresponding to the second document.

24. The image processing apparatus according to claim 13, wherein the controller recognizes first image data based on edge of the first image data included in the image data generated by the reader,
wherein the controller recognizes second image data based on edge of the second image data included in the image data generated by the reader,
wherein the controller extracts, based on the recognized image data of the first document and the obtained text information, first destination information corresponding to the first document, and
wherein the controller extracts, based on the recognized image data of the second document and the obtained text information, second destination information corresponding to the second document.

25. A method for controlling an image processing apparatus comprising:
generating image data by reading at least a first document and a second document based on one reading instruction received from a user;
performing character recognizing processing on the image data to obtain text information; and
extracting from the obtained text information first destination information corresponding to the first document and second destination information corresponding to the second document.

26. The method according to claim 25, further comprising transmitting, by a network interface, the extracted first destination information and the extracted second destination information to an external terminal.

27. The method according to claim 26, wherein the extracted first destination information and the extracted second destination information, which are transmitted by the network interface, can be modified by the external terminal.

28. The method according to claim 26, wherein a destination of the external terminal can be set by a user.

29. The method according to claim 25, wherein the first destination information corresponding to the first document and the second destination information corresponding to the second document can be extracted as destination information corresponding to different documents.

30. The method according to claim 25, wherein the extracted first destination information is an e-mail address and the extracted second destination information is an e-mail address.

31. The method according to claim 25, wherein the extracted first destination information is a facsimile number and the extracted second destination information is a facsimile number.

32. The method according to claim 25, wherein the extracted first destination information is an e-mail address and the extracted second destination information is a facsimile number.

33. The method according to claim 25, wherein the first document is a first business card and the second document is a second business card.

34. The method according to claim 25, further comprising extracting from the obtained text information a first name corresponding to the first document and a second name corresponding to the second document.

35. The method according to claim 25, further comprising:
recognizing first image data based on edge of the first image data included in the image data generated by reading;
recognizing second image data based on edge of the second image data included in the image data generated by reading;
extracting, based on the recognized image data of the first document and the obtained text information, first destination information corresponding to the first document; and
extracting, based on the recognized image data of the second document and the obtained text information, second destination information corresponding to the second document.

36. A non-transitory computer-readable storage medium storing a program for causing a computer to execute steps of a method for controlling an image processing apparatus, the method comprising:
generating image data by reading at least a first document and a second document based on one reading instruction received from a user;
performing character recognizing processing on the image data to obtain text information; and
extracting from the obtained text information first destination information corresponding to the first document and second destination information corresponding to the second document.

37. An image processing system that includes an image processing apparatus and an external terminal,
the image processing apparatus comprising:
a reader that generates image data by reading at least a first document and a second document based on one reading instruction received from a user;
a controller that performs character recognizing processing on the image data to obtain text information, and extracts from the obtained text information first destination information corresponding to the first document and second destination information corresponding to the second document; and
a network interface that transmits the extracted first destination information and the extracted second destination information to the external terminal,
the external terminal comprising:
a display that displays the first destination information and the second destination information that are transmitted by the network interface.
